(19) United States
(12) Patent Application Publication
(10) Pub. No.: US 2005/0259080 A1
(43) Pub. Date: Nov. 24, 2005

(54) Apparatus, method and computer-readable media having key mode override

(75) Inventor: Linda Cole, Lutherville, MD (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: UNITED PARCEL OF AMERICA, INC.

(21) Appl. No.: 10/851,948

(22) Filed: May 20, 2004

(51) Int. Cl. G09G 5/00

(52) U.S. Cl. 345/168

(57) ABSTRACT

An apparatus receives key mode and input data generated by a user's operation of its keys. The keys generating the input data can be shared to generate different data depending upon how the key mode data is set by a mode key. For example, one key mode can designate numeric input data and another key mode can designate alphabetic data, so that the input data generated by user activation of the same key is a numeric or alphabetic character depending upon the set key mode. If the user enters input data in the incorrect key mode, the apparatus is programmed to automatically detect and correct such erroneous data entry by overriding the key mode to change the input data if it determines that property data in the computer program it is executing requires that the input data be in a different format corresponding to another key mode. Also disclosed is a related method and device-readable media.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND OF THE INVENTION

1. Field of the Invention

This invention relates to computing devices intended for operation by human users, which thus have user interfaces with keyboards or keypads, and screen displays, to permit the user to interact with the processors of such devices. The keys permit users to input alphabetic and numeric characters as well as functions, while mode keys permit the user to change the characters, numbers, and functions output by activating the keys in accordance with the key mode selected.

2. Description of the Related Art

Computing devices typically have keyboards or keypads with keys defining multiple alphanumeric characters or functions, and one or more mode keys which enable the user to change the character or function output by the keys based on whether or not the mode key is pressed or locked. Examples of mode keys include, for example, ‘shift,’ ‘alt,’ ‘control,’ ‘capitals lock’ or ‘number lock’ keys which change the output of a key if they are activated. Input keys that generate different output depending upon the state of a mode key are sometimes referred to as ‘shared keys.’ Such shared keys are used extensively not only for the user interfaces of desktop computers, but even more extensively with hand-held computing devices. This is because hand-held devices tend to be compact with limited space for their keyboards or keypads. By making the keys capable of generating different character or number data through the use of mode keys, fewer keys are required to operate the computing device. Thus, the computing device can be made more compact than it otherwise could be.

It is often a source of frustration for users of computing devices to operate the keys to input data only to find that the device is in the incorrect key mode, resulting in improper input to the computing device. The resulting input cannot be validated by the software of the computing device and thus results in an error message requiring the user to re-enter the previously keyed data. For example, if the mode key of a computing device is set to alphabetic input while the screen displayed calls for numeric input, e.g., a zip code field, then the computing device generates an error message to the user. The user must shift the mode key to toggle the key mode of the computing device and re-key the data previously input. Clearly, repeating input can be a source of frustration for the user in that it requires redundant action of the user and leads to wasted time. In many industries, such waste of time can translate into significant worker frustration, lost time, and added costs through additional labor required. Furthermore, due to the small size of many computing devices, input of data can be a non-trivial effort because of the small size of the keys and limited number of fingers that can be used at one time to input data.

This problem is commonly faced in the package delivery business of carriers such as UPS, Inc., the assignee of the present invention. Workers in this business use hand-held devices in order to receive and transmit messages, enter data relevant to a package or shipment, consignor, consignee, etc. The particular device used by UPS, Inc. is known as the Delivery Information Acquisition Device (DIAD), e.g., the DIAD3 or DIAD4 unit. UPS, Inc. workers have encountered the problem of inputting data while having the computing device set in the incorrect key mode, resulting in incorrect key entry, resulting in an error message and the need to re-key the data in the proper key mode. Given the scale of operations of a carrier such as UPS, Inc., savings of even a minute or two per day per worker by avoiding the need to re-key data can translate into enormous cost savings for the company in terms of worker satisfaction and retention, elimination of wasted time, and labor costs. However, while this problem is acute within the package delivery industry, this problem pervades virtually all industries in which computing devices with mode keys are used to input data. It would be highly desirable to provide a solution which can overcome this problem, and provide the benefits derived from overcoming the above-described disadvantages of previous technologies.

### SUMMARY OF THE INVENTION

The disclosed method, apparatus, and device-readable media, in their various embodiments, overcome one or more of the above-mentioned problems, and achieve additional advantages as hereinafter set forth.

Broadly stated, the disclosed method, apparatus, and device-readable media of the invention function to automatically override a key mode of a computing device to change input data generated by a shared input key generating input data that varies depending upon the key mode. In essence, the key mode override function determines that the user must have intended to enter input data in a different key mode than in effect at the time of the user's key entry. This can be used to save the user the trouble of receiving an error message, changing the key mode, and re-entering input data using one or more keys of the computing device.

To set the key mode, the method, apparatus, and media can be implemented to receive mode data as set by a user-activated mode key of the computing device. The user can generate input data by operation of one or more input keys of the computing device. Key entry can be solicited of the user by the computing device with a prompt on a screen display. The key mode override function changes the input data resulting from user activation of an input key into different input data for another key mode than that in effect at the time of key entry, that is mapped to the same input key that was activated by the user. More specifically, in order to determine whether key mode override is necessary, the disclosed method, apparatus, and media can compare the key mode data with property data defining the input data required by the computer program, and determine from this comparison if the key mode data for the input data is correct. The automatic overriding step can thus be performed if the determining establishes that the key mode data is not correct for the input data as input by the user.

A method in accordance with one relatively specific embodiment of the invention is performed by a processor of an apparatus. The method prompts a user with a screen display to enter key mode data and input data. The key mode data is generated by the user through operation of a mode key, and the input data generated by the user through operation of an input key. The input data differs depending upon the key mode data so that different input data can be generated by the user with the same input key depending upon how the user has set the key mode data with the mode key. The method also comprises receiving the key mode data and input data generated by the user of the apparatus, and comparing the key mode data and property data associated with the input data prompted by the screen display. The property data defines a property expected of the input data prompted by the screen display as set by a computer program executed by the processor to receive and process the input data. The method further comprises determining if the key mode data for the input data is correct based on the comparing step. In addition, the method comprises an overriding step executed if the key mode data is determined not to be correct in the determining step. This step overrides the key mode data to change the received input data to different input data for a different key mode than that designated by the received key mode data. This different input data is mapped by the computer program to the same input key as the received input data. The method can further comprise processing the input data in various ways, either as left unchanged if the key mode data is determined to be correct, or as changed by the processor if it determines that the user intended different input data. The processing of the changed or unchanged data can comprise executing the computer program using the changed or unchanged input data, generating a screen display including the changed or unchanged input data, storing the changed or unchanged data in a database of a memory, wirelessly transmitting the changed or unchanged data to a remote computer, or combinations of the above processing. The key mode data can have a first state in which the input data designates alphabetic characters, and a second state in which the input data designates numeric characters. In this case, the apparatus can automatically correct input data in numeric key mode to alphabetic key mode, or vice versa, to automatically correct a key mode error. The property data can designate alphabetic and numeric data corresponding to respective key modes. This property data, defined within the computer program, can thus by used to determine if the input data from the user is supposed to be in alphabetic or numeric format, enabling the apparatus to automatically correct the input data that is in improper format due to a key mode error. The property data can also define a default key mode to accept input data that is alphanumeric data that can designate alphabetic, numeric, or mixed alphabetic-numeric characters.

A device-readable medium according to an embodiment of the invention stores a computer program that is executed by a computing device to prompt a user with a screen display to enter input data using a mode key designating key mode data and an input key designating input data that differs depending upon the key mode data. The computer program is executed by the computing device to receive the key mode data and input data generated by the user. The computing device compares the key mode data and property data defined by the computer program to be associated with the input data prompted by the screen display. The computing device further determines if the key mode data for the input data is correct, based on the comparing step. If the key mode data is determined not to be correct in the determining step, the computer program is executed by the computing device to override the key mode data to change the input data. The input data is changed to input data corresponding to a different key mode than that set by the received key mode data, which is mapped to the same input key activated by the user. The computer program can further be executed by the computing device to process the input data in one or more of various ways. For example, the computing device can execute the computer program using the input data as changed or left unchanged as input by the user. The computing device can process the changed or unchanged input data by generating a screen display including the changed or unchanged input data. The computing device can process the changed or unchanged input data by storing it in a database of a memory. The computing device can further execute the computer program to wirelessly transmit the changed or unchanged input data to a remote computer. The key mode data can have a first state in which the input data designates alphabetic characters, and a second state in which the input data designates numeric characters, so that input data can be corrected from alphabetic to numeric characters, or vice versa, if a key mode error is detected. The property data can designate at least one of alphabetic and numeric data corresponding to respective key modes, enabling the computing device to detect a key mode error in user-keyed input data. Furthermore, the property data can define a default key mode to accept input data that includes alphanumeric characters.

A computing device in accordance with an embodiment of the invention comprises a key unit, a memory, a display unit, and a processor. The key unit includes at least one mode key for generating key mode data, and at least one input key for generating input data that differs depending upon the key mode data. The memory stores a computer program for processing the input data. The computer program defines property data for the input data which defines the format (e.g., numeric, alphabetic, alphanumeric, etc.) expected for the input data. The display unit generates a screen display based on screen display data. The processor is connected to the key unit, memory, and display unit. The processor executes the computer program to generate and output the screen display data to the display unit so as to include a prompt on the screen display for a user to enter key mode data and input data using the key mode and input keys, respectively. The processor receives key mode data and input data based on user operation of the key mode and input keys. The processor further executes the computer program to determine if the key mode data is correct for the input data prompted from the user by comparing the key mode data and property data defined for the prompted input data as set by the computer program. The processor executes the computer program to process the received input data if the key mode data is correct for the input prompted from the user. Alternatively, the processor changes the received input data to changed input data for a different key mode that is mapped to the same input key as the received input data if the key mode data is not correct for the input data prompted from the user, and the processor executes the computer program to process the changed input data. The key mode data can have a first state in which the processor interprets the input data as alphabetic characters, and a second state in which the processor interprets the input data as numeric characters. The property data can designate alphabetic and numeric data corresponding to respective key modes. The property data can define a default key mode to accept input data that is alphanumeric data. The processor can process changed or unchanged input data to store the same in a database in the memory, to transmit changed or unchanged input data to a remote computer with a transceiver of the computing device, and/or by generating screen display data to display the input data as changed or left unchanged by the processor in a corresponding field of the screen display.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an apparatus in accordance with the invention, which comprises a processor, memory, key unit, display unit, and optional transceiver, which executes a computer program including a key mode override module.

FIG. 2 is a general flowchart of a method in accordance with the invention, which can be executed by the processor of the apparatus of FIG. 1 under control of the computer program with the key mode override module.

FIG. 3 is a schematic diagram of the flow of key mode data and input data entered by the user with a key unit, showing how this data is processed by the key mode override module in order to change the input data from alphabetic to numeric key mode.

FIG. 4 is a schematic diagram of the flow of key mode data and input data entered by the user with a key unit, showing how this data is processed by the key mode override module in order to change the input data from numeric to alphabetic key mode.

### DESCRIPTION OF THE PREFERRED EMBODIMENTS

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Definitions

‘Alphabetic’ refers to characters of an alphabet.

‘Alphanumeric’ refers to characters that are either alphabetic or numeric, or a combination of alphabetic and numeric characters.

‘And/or’ means ‘one, some, or all’ of the things immediately preceding and succeeding this phrase. Thus, ‘A, B and/or C’ means ‘any one, some or all of A, B and C.’

‘Apparatus’ as used herein is a processor-based device such as the apparatus of the embodiments disclosed herein. It is also used synonymously with ‘computing device’, ‘computer’ or ‘device’ to refer to the apparatus disclosed herein. It generally comprises a processor, memory, key unit, and display unit. It can be a hand-held unit such as a personal digital assistant (PDA), cellular telephone, pager, compact disc (CD) player, digital video disc (DVD) player, and other computing devices. Furthermore, it can be a server, mainframe, miniframe, desktop or other form of computer.

‘Computer program’ or ‘application’ refers to source code that can be compiled into object code, or object code executable by a processor, to carry out programmed tasks.

‘Connection’ or ‘Connected’ refers to the existence of a signal path permitting communication between two elements, which may be formed by virtually any medium, including a waveguide such as wire, electrically-conductive lines, cable, optical fiber, or a wireless medium such as air or space. Elements connected together may be directly connected via the communication medium, or indirectly connected through a series of connections with intermediate elements.

“Dialog box’ is a window displayed by a system or application to solicit a response from a user.

‘Format’ or ‘Property’ refers to one or more attributes associated with data, and can include character set (e.g., English alphabet, Cyrilic alphabet, Arabic alphabet, Chinese characters, Japanese characters, etc.) style (e.g, italics, bold, underline), font (e.g., Arial, Times New Roman, etc.), size (e.g., 6, 8, 10, 12, 14, 16, 18, 24, 36 point type, etc.), effects (e.g., underline, subscript, superscript, etc.), color, and possibly others.

‘Function’ is a subroutine within a module or computer program.

‘Hand-held device’ can include any portable device that can be held by hand, including, for example, a personal digital assistant (PDA), cellular telephone, pager, compact disc (CD) player, digital video disc (DVD) player, and other computing devices.

‘Memory’ or ‘device-readable medium’ refers to virtually any element capable of storing data and/or code that can be read by a processor. “Memory’ includes within its meaning a random-access memory (RAM) such as synchronous dynamic access RAM (SDRAM), read-only memory (ROM), flash memory, compact disc (CD), digital video disc (DVD), hard disk drive unit, disk storage unit, magnetic tape, etc.

‘Module’ or ‘object’ refers to a part of a computer program, usually having defined input and defined output so that the internal code of the module is not required to be accessed by other modules or parts of a computer program.

‘Numeric’ refers to characters that are numbers.

‘Operating system’ enables a processor to communicate with other elements of a computing device. The operating system can be one of the systems sold under the marks Windows® CE, Palm OS, DOS, Windows® 95, Windows® 98, Windows® 2000, Windows® NT, Windows® XP, OS/2, OS/360, OS/400, iSeries, eSeries, pSeries, zSeries, UNIX, LINUX, and numerous others.

‘Processor’ can be virtually any element capable of processing data, including a microprocessor, microcontroller, programmable gate array, field programmable gate array (FPGA), programmable logic array (PLA), programmable array logic (PAL), etc. The processor can be configured to process data in electromagnetic-form including electrical, optical, electro-optical, or magnetic data, for example.

‘(s)’ or ‘(ies)’ means one or more of the thing meant by the word immediately preceding the phrase ‘(s)’. Thus, “key(s)” means “one or more keys.”

1. General Apparatus

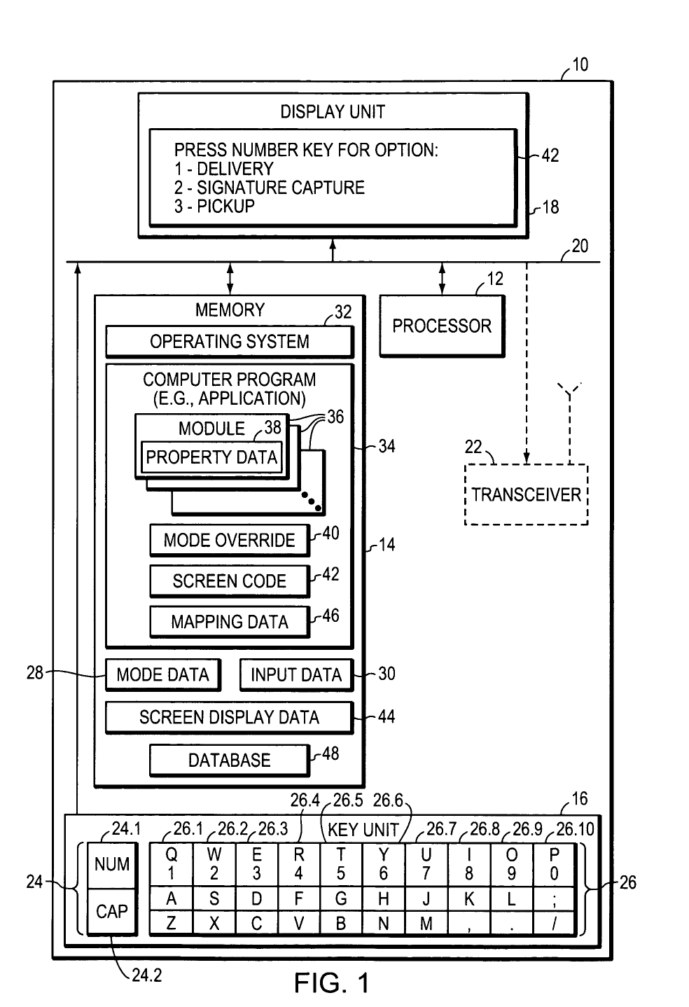

An apparatus 10 in accordance with an embodiment of the invention is shown in FIG. 1. In FIG. 1, the apparatus 10 comprises a processor 12, memory 14, key unit 16, display unit 18, and bus 20. The processor 12, memory 14, key unit 16, display unit 18 are connected to communicate with one another via the bus 20. In addition, the apparatus 10 can comprise a transceiver 22 connected to the bus 20. The transceiver 22 is indicated in broken line to indicate that it is an optional element that is generally included for use in wireless or ported communications with a remote element such as a network server or computer.

The key unit 16 has at least one mode key 24 and at least one input key 26. Upon activation by a user, the mode key(s) 24 generates key mode data 28. If the input key(s) 26 is activated by a user, such key generates input data 30. Depending upon the state of the key mode data 28 generated by the mode key(s) 24, the processor 12 interprets the activation of the input key(s) 26 differently. More specifically, in the exemplary embodiment of FIG. 1, if the mode key 24 is in one state, the input data 30 generated by activation of the input key(s) 26 is a first set of alphanumeric characters or character fonts. If the mode key 24 is in a second state, the input data 30 generated by activation of the input key(s) 26 is a second set of alphanumeric characters or character fonts that is different from the first set. Thus, the mode key 24 impacts what the processor 12 interprets the user-activated input key 26 to signify. The use of the mode key(s) 26 increases the range of alphanumeric characters and associated properties that can be generated by the user for input to the processor 12.

In terms of the type and size, the key unit 16 is not generally restricted in terms of what it can be in order to be implemented effectively in the invented apparatus 10. For example, the key unit 16 can be a standard sized “QWERTY” keyboard designed to be operated with all ten fingers. Alternatively, the key unit 16 can be a miniaturized keyboard common in many web browser, email, PDAs, miniaturized computers, cellular telephone, and other hand-held computing devices, which can be operated with fewer fingers.

In the specific embodiment of FIG. 1, the mode keys 24 include a “NUM” key and a “CAP” key. The “NUM” key signifies that the output of dual-purpose input key(s) 26 is to be numeric if activated, and non-numeric otherwise. For example, if the “NUM” key 24.1 is activated and the input key 26a is pressed, the processor 12 interprets the activated mode key 24.1 and input key 26.1 to signify that “1” has been input. Conversely, if the mode key 24.1 is not activated as the key 26.1 is pressed, then the key activation is interpreted by the processor 12 to be the alphabetic character “Q.” Similarly, the activation of the other keys 26.1-26.10 generates different outputs depending upon the state of the key mode data 28 entered via the mode key(s) 24.

Similarly, the “CAP” mode key 24.2 can be activated to cause the processor 12 to interpret activation of the keys 26.1-26.10 as capital case alphabetic characters “Q”, “W”, “E”, “R”, “T”, “Y”, “U”, “I”, “O”, “P”, respectively. If the mode key 24.2 is deactivated, then the processor 12 signifies the key mode data 28 and the input data 30 to generated by activation of keys 26.1-26.10 to signify the lower case set of alphabetic characters “q”, “w”, “e”, “r”, “t”, “y”, “u”, “i”, “o”, “p”.

Thus, a mode key 24 can be used to generate key mode data 28 which signifies different sets of input data 30 depending upon the state of the mode key 24. The mode key 24 can be used to distinguish between numeric and alphabetic characters as with mode key 24.1, capital and lower case alphabetic characters letters as with mode key 24.2, and other different character sets. The mode key 24 can be used to signify character sets that are distinguished by different characters, fonts, styles (e.g., italic or bold), character sizes, and effects such as subscript, superscript, strikethrough, etc.

The processor 12 can be programmed to interpret the mode key(s) 24 as being activated if the mode key is held down by the user when simultaneously stroking an input key 26. Alternatively, the processor 12 can be programmed to interpret the mode key(s) 24 as designating a change of key mode upon press and release of the mode key 24.1. Thus, for example, the processor 12 can be programmed to interpret the first press and release of the mode key 26 to signify to the processor 12 that the stroke of an input key 26 is a numeric character. The second press and release of the mode key 26 signifies to the processor 12 that the user has changed the key mode to a second state in which the processor 12 interprets activation of the input keys 26 as alphabetic characters. Pressing the mode key 26 again can result in the key mode state returning to the first state designating numeric input. Cycling between two states in this manner is referred to as “toggling.” Alternatively, the mode key 26 can be implemented so as to cycle through a succession of more than two states with each activation of the mode key. The set of characters output by activation of the key unit is interpreted by the processor 12 differently for each key mode.

The processor 12 receives the key mode data 28 and the input data 30 from the key unit 16. More specifically, the processor 12 executes its operating system 32 in order to obtain the key mode data 28 and the input data 30 from the key unit 16 via the bus 20 when it senses that a key 24, 26 has been activated by the user. The processor 12 stores this data received via the operating system 32 in the memory 14 via the bus 20.

The processor 12 executes the computer program 34 to perform a task for the user. The computer program 34 can be programmed to have one or more modules or objects 36 that have defined properties 38 for user input data 30 received from the key unit 16 requiring such input data to be in one of several different forms. For example, a module 36 of the computer program 34 can require the input data 30 to be in one of ‘numeric’, ‘alphabetic’, ‘alphanumeric’ or ‘default’ key modes. If the property data 38 is set to ‘numeric’, then the module 36 expects the input data 30 to be in ‘numeric’ format. If the property data 38 is set to ‘alphabetic’ format, then the module 36 expects the input data 30 to be in alphabetic format. If the property data 38 is set to ‘alphanumeric’ format, then the object or module 36 expects the input data 30 to be in alphanumeric format. If the property is set to ‘default’, then the input data 30 can be in any format whatsoever, and the processor 12 will store it in association with its corresponding variable in the code 36 of the computer program 34.

The computer program 34 comprises a key mode override module 40 which is executed by the processor 12 to override the key mode data 28. The processor 12 overrides the key mode data 28 if it determines that the key mode set by this data is not correct for the property data 38, as defined in the computer program 34 and prompted by the screen display 42, is not correct for the input data 30 as keyed by the user. More specifically, the processor 12 compares the data 28 with the property data 38 for the module 36 receiving the input to determine if the key mode is correct for the input solicited from the user by the screen display 42. If the key mode data 28 is incorrect, the processor 12 uses the mapping data 44 to determine if input data 30 activated by the same input key 26 in a different key mode results in input data with property data 38 matching that defined by the computer program 34. Conversely, if the key mode data 28 is correct for the property data 38, then the processor 12 leaves the input data 44 as it was received from the key unit 16.

For example, in FIG. 1, the processor 12 executes the screen code 42 to generate the screen display data 44. The screen display data 44 can be bmp, jpg, gif, tif, or otherwise formatted data. The processor 12 further provides the screen display data 44 to the display unit 18 which generates the screen display 42. In this example provided by way of illustration and not limitation, the screen display 42 contains the following text:
PRESS NUMBER KEY FOR OPTION:
1—DELIVERY
2—SIGNATURE CAPTURE
3—PICKUP

Thus, the screen display 42 prompts the select from options in the menu by entering “1” if the user desires to process a package delivery, “2” if the user desires to capture a signature from a consignee to acknowledge package delivery is to be undertaken, or “3” if the user desires to process a package pickup. Assuming the user has the mode key 24.1 set for alphabetic rather than numeric input, the key mode data 28 and input data 30 designate a “Q” (represented by the binary expression “0101 0001”) upon the user's activation of the key 26.1. In executing the key mode override module 40, the processor 12 compares the letter “Q” with the property data 38 for the module 36 to receive the input from the user's activation of the key unit 16. In this case, the property data 38 has been defined by the programmer to indicate that the input is to be ‘numeric’ because the input options, i.e., the numbers “1” “2” “3”, are all numeric in nature. Hence, the processor 12 executes the key mode override module 40 to detect an error in the key mode data 28 because the letter “Q” is not in the numeric format expected by the property data 38 for the module 36 to receive the key mode data 28 and input data 30 as inputs. The key mode override module 40 thus refers to the mapping data 46 to determine what the numeric equivalent of the letter “Q” is assuming the key mode data 46 is incorrect so that another key mode must have been intended by the user. The processor 12 thus determines that if the key mode data 28 were set in a different state as initially received from the key unit 16, i.e., the numeric key mode, then the user's input is interpreted by the processor 12 as a numeric “1” rather than an alphabetic “Q.” The key mode override 40 then feeds the changed input data 30, in this example a numeric “1”, to the module 36 receiving the input data 30. Because “1” is a valid entry under the property data 38 for the module 36.1, processing proceeds as it normally would have if the user had entered “1” initially. Thus, in this example, the computer program 34 executes a delivery routine appropriate for the user to deliver a package to a consignee.

It should be understood that the foregoing description is an example intended only to illustrate the operation of the invention, and is not intended to limit scope of the invention, especially not as concerns the specific numbers and letters input by the user. To the contrary, this example is intended to illustrate the broader concept of how the override module 40 can determine the key mode to be incorrect by comparing the property data 38 to the key mode data 28 and automatically change the input data 30 to the correct format if input data for another key mode mapping to the same input key activated by the user produces input data with the property(ies) expected by the computer program 34. Thus, the user is spared the trouble of having to receive and read an error message and re-key the input data 30 correctly because the override module 40 permits the processor 12 to correctly interpret the user's input even though the incorrect key mode was used to enter the input data. In the event the input data 38 is determined to be invalid after it is changed, the computer program 34 is such as to cause the processor 12 to generate an error message to the user on the display unit 18.

Also, although the input data 30 in FIG. 1 is a menu selection, the screen display 42 can be such as to solicit data entry from the user. For example, the screen display 42 can request input data 30 such as data for a shipment such as consignor data (e.g., a package sender's name, company, company address, telephone number, etc.), consignee data (e.g., a package receiver's name, company, address, telephone number, etc.), and package data (e.g., package weight, dimensions, contents, warnings (e.g., notices regarding fragile or hazardous contents), etc.). In this case, the memory 14 can be provided with a database 48 to store the input data 30 as changed by the key mode override module 40, or as left unchanged. In addition, in computer programs in which the apparatus 10 is used in a package shipping context, the processor 12 can be programmed by the computer program 34 to transmit the input data 30 to a remote server for storage and/or processing. This commonly occurs, for example, in package tracking contexts in which the input data 30 entered into the apparatus 10 by the user can be uploaded to a remote package tracking server for storage and later retrieval by those who wish to access package tracking information. Furthermore, the input data 30 can be transmitted to a remote server for processing, e.g., to generate handling instructions for the package, for example, instructing workers or machines as to how to sort, route and otherwise handle a package.

2. General Method

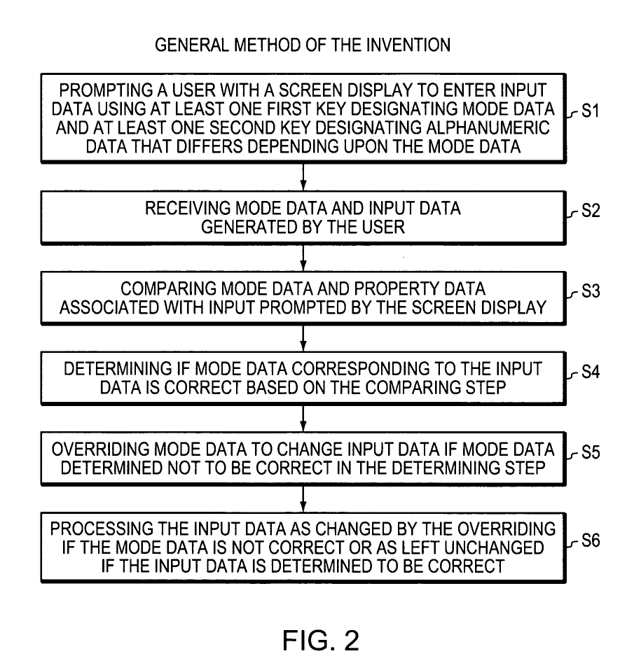

FIG. 2 is a general method of the invention. This method can be carried out by the processor 12 of FIG. 1 as it executes the computer program 34 including the key mode override module 40. In Step S1 of FIG. 2 the user is prompted with a screen display to enter input data 30 using at least one mode key 24 designating key mode data 28, and at least one input key 26 designating input data 30. The input data 30 can be alphanumeric data. The input data 30 differs depending upon the key mode data 28. In Step S2 the key mode data 28 and input data 30 are received. This step can be performed by the processor 12 by executing the operating system 32 to receive input from the user resulting from the user's operation of the key unit 16. In Step S3 the key mode data 28 is compared with property data 38 associated with the input data prompted from the user by the screen display. The property data 38 can be defined by the module 36 of the computer program 34 that is to receive such property data. In Step S4 a determination is made to establish if the key mode data 28 corresponding to the input data 30 is correct based on the comparing of Step S3. In Step S5 the key mode data 28 is overridden to change the input data 30 to a correct value if the key mode data 28 is determined not to be correct in the comparing of Step S4. Thus, if the state of the key mode data 28 is incorrect for the input data 38 expected by the module 36, then the processor 12 executes the key mode override module 40 to change the input data 30 to a correct value. The processor 12 can accomplish this task using the mapping data 40 which maps the characters assigned to each key mode. If the processor 12 determines that no key mode produces input data 30 with correct property data 38, then the processor 12 executes the key mode override module 40 to generate an error message. In Step S6, processing of the input data 30 as changed if the key mode data 28 is incorrect, or as left unchanged if the input data 30 is determined to be correct in Step S4, is carried out. The processor 12 can process the input data 30 in various ways, such as by executing the modules 36 to process the input data 30, by generating screen display data 44 provided to the display unit 42 to generate a screen display 42 including the input data 30, by storing the input data 30 in the database 48, by transmitting the input data 30 to a remote server for storage, or some combination of these functions, for example.

3. Exemplary Data Flow

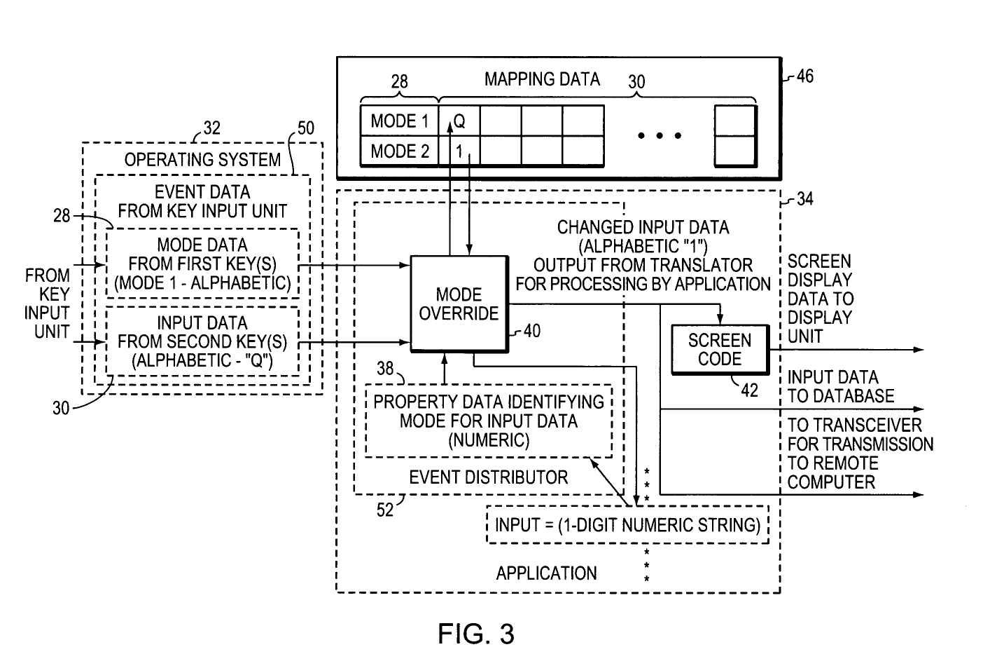

In FIG. 3, the general data flow of the key mode data 28 and input data 30 is shown. The processor 12 executes the operating system 32 which receives the key mode data 28 and the input data 30. The operating system 32 is triggered to receive the input upon activation of a mode key 24 and/or input key 26. This activation can be defined as an ‘event’ triggered by activation of a key, and thus the key mode data 28 and input data 30 can be termed event data 50. Hence, in this embodiment, the portion of the computer program 34 containing the key mode override module 40 is referred to as an event distributor 52 because it is programmed to receive event data 50 and distribute it to the module programmed to process the event data 50. The key mode override module 40 of the computer program 34 receives the key mode data 28 and the input data 30, which in this example indicates “key mode 1-alphabetic” and the alphabetic letter “Q” in this key mode. The key mode override module 34 is executed by the processor 12 to compare the key mode data 28 with the property data 38 identified in the computer program 34. In this case, the portion of the computer program 34 ‘listening’ for events from the key unit 16 has an input variable INPUT that is associated with the property data 38 that in this example is a 1-digit numeric string. The key mode override module 40 compares the key mode data 28 with the property data 38 to determine if the key mode data 28 is correct for the input expected from the user. If the key mode override module 40 determines that the key mode data 28 is not correct, the key mode override module 40 determines whether any other key mode contains input data 30 that constitutes satisfactory input to the code segment receiving the input data 30. In this case, the only other key mode is “key mode 2-numeric” and the key mode override module 40 determines that the number “1” in key mode 2 corresponding to the letter “Q” in key mode 1, must have been the input intended by the user because it has the numeric property expected by the code of the computer program 34. Hence, the key mode override unit 40 overrides the key mode set by key mode data 28 and changes the input data 30 from “Q” to “1.” Processing of the changed input data 30, i.e., numeric “1”, thus proceeds as it normally would have had the input data 30 been input in the correct key mode.

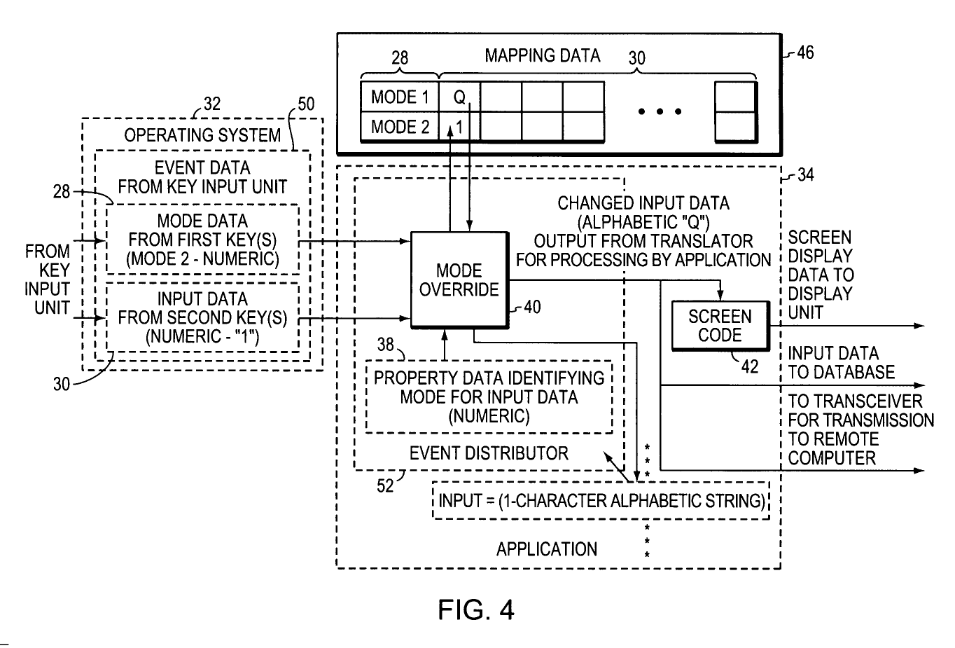

FIG. 4 demonstrates the opposite case from FIG. 3 in which the user inputs key mode data 28 specifying “key mode 2-numeric” and input data 30 indicating “numeric -1” when the user actually intended to input an alphabetic “Q” in response to a screen display 42 prompting user input. In this case, the key mode override module 40 compares the property data 38 with the key mode data 28 and determines that the key mode data 28 is set incorrectly because the input variable INPUT requires a 1-character alphabetic string, whereas the input data 30 is numeric as set by the key mode data 28. The override module 40 therefore overrides the key mode set by the user by referring to mapping data 46 to determine that the numeral “1” in key mode 2 shares the same input key 26 as the letter “Q” in alphabetic key mode 1. The key mode override module 40 determines that the letter “Q” is a valid input given the property data 38 definition of a 1-character alphabetic string. Thus, the key mode override module 40 implemented within the event distributor 52 of the computer program 34 outputs the changed input data 30, i.e., the letter “Q”, to the screen code 42. As the processor 12 executes the screen code 42, it generates screen display data 44 which it outputs to the display unit 18 to generate the screen display 42 based on the screen display data 44. Furthermore, the processor 12 can process the changed input data 30 by saving the changed input data 30 in the database 48. The computer program 34 can as well process the changed input data 30 by transmitting it to a remote computer (e.g. a web server via public network such as the Internet, or by private network) for storage and/or further processing.

4. Computer Code

The following is exemplary code for a module 36 of the computer program 34.

```
//**********************************************************************
// COPYRIGHT (C) 2002-2004 BY UNITED PARCEL SERVICE OF AMERICA, INC.
// All Rights Reserved.
//**********************************************************************
//
//**********************************************************************
//* @FUNCTION: CEventDistributor::translateEvent
//*
//* @SYNOPSIS:
//*
//* @FUNC_DESC: This function is called upon to translate a windows
//*  virtual key to a DIAD application key code.
//*  This function will also convert a key from alpha<->numeric
//*  based on the input key mode for the current panel/field.
//*
//* @SIDE_FX: None
//*
//* @PARAM : EVENTPTR Pointer to current event
//*
//* @RETURNS: BOOL TRUE if event has been translated
//*  FALSE if event should not be processed
//*
//* @NOTES: None
//*
//* @TARGET: DIAD4
//*
//* @FEND
//**********************************************************************
typedef struct {
  s_short nWindowsKeyCode;
  s_short nDiadKeyCode;
} KEYCHAR_MAP_ENTRY;
typedef struct {
  s_short nWindowsKeyCode;
  s_short nWParamKeyCode;
  s_short nDiadKeyCode;
} KEYDOWN_MAP_ENTRY;
//* These tables map device specific virtual scan codes to application
//* specific key codes.
//*
static KEYCHAR_MAP_ENTRY KeyCharMapTable [ ] =
{
//* Input Key wMsg
  { _T(‘_’), KEY_ALTKEY, }, //* Underline
  { _T(‘-’), KEY_ALT_SOFT1, }, //* Hyphen
  { _T(‘/’), KEY_ALT_SOFT2, }, //* Slash
  { _T(‘\\’), KEY_ALT_SOFT3, }, //* Backslash
  { _T(‘*’), KEY_ALT_SOFT4, }, //* Asterisk
  { _T(‘(’), KEY_ALT_SOFT5, }, //* Left Parenthesis
  { _T(‘)’), KEY_SIGNATURE, }, //* Right Parenthesis
  { NULL, NULL, }, //* This must be the last entry in the table.
};
static KEYDOWN_MAP_ENTRY KeyDownMapTable [ ] =
{
//* Input Key wParam wMsg
  { VK_F6, VK_F6, KEY_ALTKEY, },
  { VK_F1, VK_F1, KEY_SOFT1, },
  { VK_F2, VK_F2, KEY_SOFT2, },
  { VK_F3, VK_F3, KEY_SOFT3, },
  { VK_F4, VK_F4, KEY_SOFT4, },
  { VK_F5, VK_F5, KEY_SOFT5, },
  { VK_F7, VK_F7, KEY_SIGNATURE, },
  { VK_UP, VK_UP, KEY_UPARROW, },
// { 0x00E9, VK_UP, KEY_UPARROW, }, //* CTRL-Tab ???
  { VK_F9, VK_F9, KEY_SCAN, },
  { VK_PRIOR, VK_PRIOR, KEY_BIGUP, },
  { VK_TAB, VK_PRIOR, KEY_BIGUP, },
  { VK_RETURN, VK_RETURN, KEY_STOPCOMP, },
  { VK_F12, VK_RETURN, KEY_STOPCOMP, },
  { VK_LEFT, VK_LEFT, KEY_LFTARROW, },
  { VK_HOME, VK_LEFT, KEY_LFTARROW, },
  { VK_DOWN, VK_DOWN, KEY_DNARROW, },
// { 0x0EA, VK_DOWN, KEY_DNARROW, }, //* ALT-Tab ???
  { VK_NEXT, VK_NEXT, KEY_BIGDN, },
// { 0x00EB, VK_NEXT, KEY_BIGDN, }, //* CTRL-Escape ???
  { VK_RIGHT, VK_RIGHT, KEY_ENTER, },
  { VK_END, VK_RIGHT, KEY_ENTER, },
  { VK_DELETE, VK_DELETE, KEY_VOID, },
  { VK_ESCAPE, VK_ESCAPE, KEY_ESCAPE, },
  { VK_BACK, VK_BACK, KEY_BACKSPACE, },
  { VK_CONTROL, VK_BACK, KEY_BACKSPACE, },
  { VK_MENU, VK_SPACE, str_SPACE },
  { NULL, NULL, NULL } //* This must be the last entry in the table.
};
//* This table maps the Alpha and Numeric values
//* on the DIAD4 shared keys
static TCHAR Num2Alpha [ ] =
{
  ‘X’, //* Maps to 0
  ‘C’, //* 1
  ‘D’, //* 2
  ‘E’, //* 3
  ‘J’, //* 4
  ‘K’, //* 5
  ‘L’, //* 6
  ‘Q’, //* 7
  ‘R’, //* 8
  ‘S’, //* 9
};
BOOL CEventDistributor::translateEvent (EVENTPTR eventp)
{
  TCHAR nKey = eventp->wmsg;
  if (eventp->nMessage == WM_KEYDOWN)
  {
    KEYDOWN_MAP_ENTRY * pKeyDownTbl = KeyDownMapTable;
    for (; pKeyDownTbl->nDiadKeyCode != NULL; pKeyDownTbl++)
    {
      if (pKeyDownTbl->nWindowsKeyCode == eventp->wmsg)
      {
        //* If this is the VK_MENU key, we have to change this
        //* from a WM_KEYDOWN message to a WM_CHAR message
        //* because VK_MENU will not send a WM_CHAR after this.
        if (eventp->wmsg == VK_MENU)
          eventp->nMessage = WM_CHAR;
        //* Save the mapped values
        eventp->wmsg = pKeyDownTbl->nDiadKeyCode;
        eventp->wParam = pKeyDownTbl->nWParamKeyCode;
        //* Do we need to convert keys based on Input Key mode?
        //* If we do, change from WM_KEYDOWN message to WM_CHAR
        //* message because we do not handle these keys as
        //* WM_CHAR after this.
        if (_curPanel->keyInputKey mode( ) == ALPHA_INPUT_KEY MODE)
        {
          if (eventp->wmsg == KEY_VOID)
          {
            eventp->wmsg = eventp->wParam = _T(‘B’);
            eventp->nMessage = WM_CHAR;
          }
          else if (eventp->wmsg == KEY_ESCAPE)
          {
            eventp->wmsg = eventp->wParam =_T(‘F’);
            eventp->nMessage = WM_CHAR;
          }
        }
        return (TRUE);
      }
    }
    if (!isprint (eventp->wmsg))
    {
      // This is not a WM_KEYDOWN that will be followed by WM_CHAR
      // Log the unexpected key event - no translation/we don't handle
      logUnexpectedEvent (eventp->wmsg);
    }
  }
  else // (eventp->nMessage == WM_CHAR)
  {
    //* Only pass on WM_CHAR keyboard events that are valid
    //* printable keys on the DIAD4 keyboard:
    //* ‘0’ - ‘9’, ‘A’ - ‘Z’, ‘.’, and space.
    //*
    //* ESCAPE, BKSP, and DELETE are handled by WM_KEYDOWN
    //* processing, so swallow the WM_CHAR event for these.
    //*
    if (str_isdigit (eventp->wmsg))
    {
      //* Do we need to convert number keys to alpha?
      if (_curPanel->keyInputKey mode( ) == ALPHA_INPUT_KEY MODE)
      {
        eventp->wmsg = eventp->wParam = Num2Alpha [_ttoi(&eventp->wmsg)];
      }
      return (TRUE);
    }
    else if (str_isupper (eventp->wmsg))
    {
      //* Do we need to convert alpha keys to numbers?
      if (_curPanel->keyInputKey mode( ) == NUMERIC_INPUT_KEY MODE)
      {
      for (int i = 0; i < 10; i++)
      {
        if (eventp->wmsg == Num2Alpha [i])
        {
          eventp->wmsg = eventp->wParam = i + _T(‘0’);
          return (TRUE);
        }
      }
      //* If we are converting B to KEY_ESCAPE or F to KEY_VOID,
      //* change from WM_CHAR message to WM_KEYDOWN message because
      //* that is how those keys are handled.
      if (eventp->wmsg == _T(‘B’))
      {
        eventp->wmsg = KEY_VOID;
        eventp->wParam = VK_DELETE;
        eventp->nMessage = WM_KEYDOWN;
      }
      else if (eventp->wmsg == _T(‘F’))
      {
        eventp->wmsg = KEY_ESCAPE;
        eventp->wParam = VK_ESCAPE;
        eventp->nMessage = WM_KEYDOWN;
      }
    }
    return (TRUE);
  }
  else if (eventp->wmsg == str_DECIMALPT)
  {
    //* Do we need to convert the Decimal key to ‘M’?
    if (_curPanel->keyInputKey mode( ) == ALPHA_INPUT_KEY MODE)
    {
      eventp->wmsg = eventp->wParam = _T(‘M’);
    }
    return (TRUE);
  }
  else if (eventp->wmsg == str_SPACE)
    return (TRUE);
  //* UNDERLINE, HYPHEN, SLASH, BACKSLASH, ASTERISK, LEFTPAREN
  //* and RIGHTPAREN are mapped to DIAD control keys.
  //*
  KEYCHAR_MAP_ENTRY * pKeyCharTbl = KeyCharMapTable;
  for (; pKeyCharTbl->nDiadKeyCode != NULL; pKeyCharTbl++)
  {
    if (pKeyCharTbl->nWindowsKeyCode == eventp->wmsg)
    {
        //* Save the mapped values
        eventp->wmsg = pKeyCharTbl->nDiadKeyCode;
        return (TRUE);
      }
    }
    // Log the unexpected key event - no translation/we don't handle
    // Don't log keys we handle with WM_KEYDOWN but also come through
    // as WM_CHARs
    if ((eventp->wmsg != 0x0008) // Backspace
    && (eventp->wmsg != 0x000d) // Carriage Return (Stop Complete)
    && (eventp->wmsg != 0x001b)) // Escape
      logUnexpectedEvent (eventp->wmsg);
  }
  return (FALSE);
}
************************************************************************
```

The foregoing code is written in C++ Version 6.0 for the apparatus 10, which in this case is the DIAD4 hand-held unit. In this example, the mapping data 46 makes the following mapping of alphabetic characters to numeric characters:

‘X’, //* Maps to 0
‘C’, //* 1
‘D’, //* 2
‘E’, //* 3
‘J’, //* 4
‘K’, //* 5
‘L’, //* 6
‘Q’, //* 7
‘R’, //* 8
‘S’, //* 9

Hence, the input keys 26 in the center area of a standard QWERTY keyboard have been assigned as dual-purpose keys in this embodiment having an input that is alphabetic or numeric, depending upon the whether the user has set the key mode to generate alphabetic or numeric input data 30.

The portion of the key mode override module 40 that converts input data 30 in the alphabetic key mode into numeric key mode is as follows:

```
      *
      *
      *
if (str_isdigit (eventp->wmsg))
    {
      //* Do we need to convert number keys to alpha?
  if (_curPanel->keyInputKey mode( ) == ALPHA_INPUT_KEY
  MODE)
      {
        eventp->wmsg = eventp->wParam =
        Num2Alpha [_ttoi(&eventp->wmsg)];
      }
      return (TRUE);
      *
      *
      *
```

The line of code ‘if (str_isdigit (event−>wmsg))’ determines if ‘eventp’ is numeric input data 30. If so, the statement ‘if (_curPanel->keyInputKey mode( )=ALPHA_INPUT_KEY MODE)’ determines whether the input solicited form the user is supposed to be alphabetic based on the ‘_curPanel’ function that defines the property data 38 for the solicited input data 30. Thus, in this example, the property data 38 is defined generally at the function level, rather than specifically at the input data level. It should be appreciated that the property data 38 can be expressly defined, from specific to general, at the input data level, the function, dialog box, or form level, the module or object level, or at the computer program or application level, for example. Thus, the property definition at each level can be effective for all input data processed at that level. The subsequent line of code ‘eventp−>wmsg=eventp−>wParam=Num2Alpha [_ttoi(&eventp−>wmsg)]’ carries out conversion of the input data 30 from numeric to its corresponding alphabetic character using the mapping data 46.

Conversely, the portion of the key mode override module 40 that converts input data 30 in the alphabetic key mode into numeric key mode is as follows:

```
  *
  *
  *
else if (str_isupper (eventp->wmsg))
{
  if (_curPanel->keyInputKey mode( ) == NUMERIC_INPUT_KEY
  MODE)
  {
    for (int i = 0; i < 10; i++)
    {
      if (eventp->wmsg == Num2Alpha [i])
      {
        eventp->wmsg = eventp->wParam = i + _T(‘0’);
        return (TRUE);
  *
  *
  *
```

The ‘else if (str_isupper (eventp−>wmsg))’ is used to establish that the input data 30 carrying the variable ‘eventp’ is an alphabetic upper case character. The statement ‘if (_curPanel−>keyInputKey mode( )=NUMERIC_INPUT_KEY MODE)’ determines that the input data 30 was expected by the function ‘_curPanel’ was expected to be in numeric format, i.e., the property data 38 is numeric for the input data 30 solicited of the user. The subsequent lines of code override the key mode set by the user to carry out the change of the input data 30 from alphabetic to numeric key mode to complete the processing of the input data 30.

Many variations or alternative configurations for the invention are possible without departing from the scope of the invention. For example, the mapping data 46 can be defined externally to the computer program 34 in a separate record, table, array, or other data structure, for example.

To appreciate the value if the disclosed apparatus, method, and device-readable medium to industry, consider the limited example of a carrier such as UPS, Inc. which is in the business of delivering packages throughout the world. Under the reasonable assumption that the average time spent by a worker to handle erroneous error input into a hand-held device such as the DIAD3 or DIAD4 due to improper key mode setting consumes a minute of a driver's time per day, the resulting costs can be enormous. This time would be required by the driver to read error messages resulting from improper input and re-enter input data in the proper key mode. At a wage of $15 per hour, not unreasonable for a delivery worker, $0.25 per day is consumed per worker per day in handling error messages and re-keying of data due to erroneous input into hand-held devices through improper key mode settings. Assuming the workforce of a carrier has 100,000 drivers using such hand-held devices worldwide, again not an unreasonable assumption, the total cost per day is $25,000 due to erroneous data entry from improper key mode setting. When multiplied over all workdays of a year, the resulting savings provided by the disclosed apparatus, method, and device-readable medium can easily reach many millions of US dollars per year for a carrier of even key moderate size. The value of the invention to industry should thus be appreciated.

1. A method performed by a processor of an apparatus, the method comprising:
(a) prompting a user with a screen display of the apparatus to enter key mode data and input data;
(b) receiving the key mode data and input data generated by the user of the apparatus, the key mode data generated by the user through operation of a mode key, and the input data generated by the user through operation of an input key, the input data differing depending upon the key mode data so that different input data can be generated by the user with the same input key depending upon how the user has set the key mode data with the mode key;
(c) comparing the key mode data and property data associated with the input data prompted by the screen display, the property data defining a property expected of the input data prompted by the screen display as set by a computer program executed by the processor to receive and process the input data;
(d) determining if the key mode data for the input data is correct based on the comparing of step (c); and
(e) if the key mode data is determined not to be correct in the determining of step (d), overriding the key mode data to change the received input data to different input data for a different key mode than that designated by the received key mode data, the different input data mapped by the computer program to the same input key as the received input data.

2. A method as claimed in claim 1 further comprising:
(f) processing the input data either as changed by the overriding of step (e) if the key mode data is not correct as determined by step (d) or as left unchanged if the key mode data is determined to be correct in step (d).

3. A method as claimed in claim 2 wherein the processing of step (f) includes executing the computer program using the input data as changed by the overriding of step (e) if the key mode data is determined not to be correct in step (d) or as left unchanged if the input data is determined to be correct in step (d).

4. A method as claimed in claim 2 wherein the processing of step (f) includes generating a screen display including the input data as changed by the overriding of step (d) if the key mode data is not correct or as left unchanged if the input data is determined to be correct.

5. A method as claimed in claim 2 wherein the processing of step (f) includes storing in a database of a memory the input data as changed by the overriding of step (e) if the key mode data is not correct or as left unchanged if the input data is determined to be correct.

6. A method as claimed in claim 2 wherein the processing of step (f) includes wirelessly transmitting to a remote computer for storage the input data as changed by the overriding of step (d) if the key mode data is not correct or as left unchanged if the input data is determined to be correct.

7. A method as claimed in claim 1 wherein the key mode data has a first state in which the input data designates alphabetic characters, and a second state in which the input data designates numeric characters.

8. A method as claimed in claim 1 wherein the property data designates at least one of alphabetic and numeric data corresponding to respective key modes.

9. A computing device as claimed in claim 1 wherein the property data can define a default key mode to accept input data that is alphanumeric data.

10. A device-readable medium storing a computer program that upon execution by a computing device executes the following steps:
(a) prompting a user with a screen display to enter input data using at least one mode key designating key mode data and at least one input key designating input data that differs depending upon the key mode data;
(b) receiving the key mode data and input data generated by the user;
(c) comparing the key mode data and property data defined by the computer program to be associated with the input data prompted by the screen display;
(d) determining if the key mode data for the input data is correct based on the comparing of step (c); and
(e) overriding the key mode data to change the input data if the key mode data is determined not to be correct in the determining of step (d).

11. A device-readable medium as claimed in claim 10 further comprising:
(f) processing the input data as changed by the overriding of step (e) if the key mode data is not correct or as left unchanged if the input data is determined to be correct in the determining of step (d).

12. A device-readable medium as claimed in claim 11 wherein the processing of step (f) includes executing the computer program using the input data as changed by the overriding of step (e) if the key mode data is not correct or as left unchanged if the input data is determined to be correct in step (d).

13. A device-readable medium as claimed in claim 11 wherein the processing of step (f) includes generating a screen display including the input data as changed by the overriding of step (e) if the key mode data is not correct or as left unchanged if the input data is determined in step (d) to be correct.

14. A device-readable medium as claimed in claim 11 wherein the processing of step (f) includes storing in a database of a memory the input data as changed by the overriding of step (d) if the key mode data is not correct or as left unchanged if the input data is determined to be correct.

15. A device-readable medium as claimed in claim 11 wherein the processing of step (f) includes wirelessly transmitting to a remote computer the input data as changed by the overriding of step (e) if the key mode data is not correct or as left unchanged if the input data is determined to be correct in step (d).

16. A device-readable medium as claimed in claim 10 wherein the key mode data has a first state in which the input data designates alphabetic characters, and a second state in which the input data designates numeric characters.

17. A device-readable medium as claimed in claim 10 wherein the property data designates at least one of alphabetic and numeric data corresponding to respective key modes.

18. A device-readable medium as claimed in claim 10 wherein the property data can define a default key mode to accept input data that includes alphanumeric characters.

19. A computing device comprising:
a key unit including at least one mode key for generating key mode data, and at least one input key for generating input data that differs depending upon the key mode data;
a memory storing a computer program for processing the input data, the computer program defining property data for the input data;
a display unit generating a screen display based on screen display data; and
a processor connected to the key unit, memory, and display unit, the processor executing the computer program to generate and output the screen display data to the display unit so as to include a prompt on the screen display for a user to enter key mode data and input data using the key mode and input keys, respectively, the processor receiving key mode data and input data based on user operation of the key mode and input keys, the processor further executing the computer program to determine if the key mode data is correct for the input data prompted from the user by comparing the key mode data and property data defined for the prompted input data as set by the computer program, the processor executing the computer program to process the received input data if the key mode data is correct for the input prompted from the user, and the processor changing the received input data to changed input data for a different key mode that is mapped to the same input key as the received input data if the key mode data is not correct for the input data prompted from the user, the processor executing the computer program to process the changed input data if the processor determines that the key mode data is not correct for the received input data.

20. A computing device as claimed in claim 19 wherein the key mode data has a first state in which the processor interprets the input data as alphabetic characters, and a second state in which the processor interprets the input data as numeric characters.

21. A computing device as claimed in claim 19 wherein the property data designates at least one of alphabetic and numeric data corresponding to respective key modes.

22. A computing device as claimed in claim 19 wherein the property data can define a default key mode to accept input data that is alphanumeric data.

23. A computing device as claimed in claim 19 wherein the processor stores the changed or unchanged input data in a database in the memory.

24. A computing device as claimed in claim 19 further comprising:
a transceiver coupled to receive the input data from the processor, the transceiver wirelessly transmitting the input data to a remote computer.

25. A computing device as claimed in claim 19 wherein the processor generates the screen display data to display the input data as changed or left unchanged by the processor in a corresponding field of the screen display.

26. A device-readable medium storing a computer program executable by a computing device to perform the following step:
(a) automatically overriding a key mode of the computing device defined by key mode data set by a user-activated mode key of the computing device, to change input data resulting from user activation of an input key of the computing device into different input data for a different key mode of the computing device, the different input data mapped to the same input key activated by the user.

27. A device-readable medium as claimed in 26 wherein the computer program stored in the device-readable medium is executed by the computing device to perform the additional steps of:
(b) comparing the key mode data with property data defining the input data required of the computer program; and
(c) determining if the key mode data for the input data is correct based on the comparing step, the automatic overriding step performed if the determining establishes that the key mode data is not correct for the input data input by the user.

28. A device-readable medium as claimed in 27 wherein the computer program stored in the device-readable medium is executed by the computing device to perform the additional step of:
(d) receiving the key mode data and input data generated by the user of the computing device.

29. A device-readable medium as claimed in 28 wherein the computer program stored in the device-readable medium is executed by the computing device to perform the additional step of:
(e) prompting a user with a screen display of the computing device to enter key mode data and input data.
